(19) United States
(12) Patent Application Publication
(10) Pub. No.: US 2006/0277046 A1
(43) Pub. Date: Dec. 7, 2006

(54) Dynamic generation of vocabulary practice

(76) Inventors: Tseela Lachish, Jerusalem (IL); Noam Shani, Reut (IL); Amit Ben Zvi, Shoham (IL); Yael Moscowitz, Mevaseret Zion (IL); Feri Ehrenfeld, Mazkeret Batya (IL)

Correspondence Address: DANIEL J SWIRSKY, 55 REUVEN ST., BEIT SHEMESH, 99544, IL

(21) Appl. No.: 11/146,285

(22) Filed: Jun. 7, 2005

(51) Int. Cl. G10L 21/00

(52) U.S. Cl. 704/272

(57) ABSTRACT

The apparatus includes an electronic dictionary and a dictionary word exercise generator to generate vocabulary exercises for any requested vocabulary-type word in the electronic dictionary. The dictionary word exercise generator includes an exercise creator to generate the exercises from at least the definition of the word in the dictionary, and a linguistic database, a distracters database and an exercise creator. The linguistic database includes at least the electronic dictionary and a thesaurus. The electronic dictionary has definitions for the dictionary words therein and often, a usage example for the dictionary words. The thesaurus has at least synonyms for its words. The distracters database stores at least one distracter set for each dictionary word, the distracter word being commonly mistaken for the dictionary word. The exercise creator creates exercises for a user selected dictionary word from at least one of its associated definition, usage example, if present, synonyms and distracter words.

### FIELD OF THE INVENTION

The present invention relates to vocabulary practice generally and to practicing of a personal list of words in particular.

### BACKGROUND OF THE INVENTION

Vocabulary exercises are known in the art. Typically, a teacher has a list of vocabulary words from which s/he creates questions for the students. The questions may take many forms, each of which is designed to check the students' understanding of and ability to use the words in the various modes and contexts.

There also exist many workbooks designed to improve a students' vocabulary. Typically, the workbook designer may select a set of vocabulary words and may use them throughout the workbook, in order to ensure that the students fully learn the words.

With the advent of computers, software programs have been developed to test vocabulary. Beret Applications LLC has a Beret Study Buddy: Vocabulary (see www. Beret. Com/vocab.php) which asks a student to enter his/her vocabulary words and their definitions, or download them from another program. Once the vocabulary words are entered, the Study Buddy generates vocabulary exercises.

Edhelper.com (www. Edhelper.com) is a website designed to help teachers generate vocabulary exercises for their students. The teachers can enter a vocabulary word, its definition and some sentences with the words in it and edhelper.com will generate the vocabulary tests.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a block diagram illustration of a dictionary word practice unit and a software application within which a person may generate potential vocabulary words;

FIG. 2 is a block diagram illustration of the details of the dictionary word practice unit of FIG. 1;

FIG. 3 is an exemplary definition used by the dictionary word practice unit of FIG. 1; and

FIGS. 4A, 4B, 4C, 4D, 4E and 4F are exemplary vocabulary exercises which the dictionary word practice unit of FIG. 1 can generate using the definition of FIG. 3.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Applicants have realized that vocabulary words are not confined to school-related activities. People constantly encounter new words, whether while reading, or writing a document, or in advertisements, etc. For some of these activities, particularly those performed on a computer of some kind, the person can get some answers about the troublesome word(s). The user can look it up in a printed dictionary, online in the Internet, or, the application s/he is using may have word lookup capabilities.

For example, the user may be editing a document with the word processing program known as WORD®, commercially available from Microsoft Corporation of the USA. If the document has a word in it that is unknown to the user, s/he may want to look it up. WORD® may then provide the user with the definition, or some synonyms or antonyms. Or, WORD® may provide the correct spelling.

Applicants have realized that the user might want to practice the troublesome words, in order to learn the word better and/or to improve his/her vocabulary. Moreover, Applicants have realized that, in the prior art, vocabulary exercises exist only for a predefined small subset of words, typically the subset defined by level or class or subject. The present invention may provide vocabulary exercises for any word in an electronic dictionary. Such a dictionary typically may have at least 25,000 words.

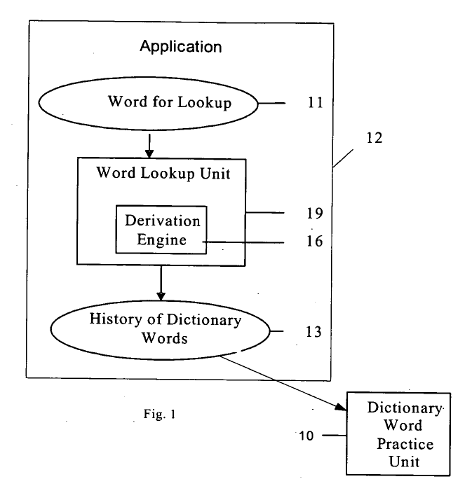

Reference is now made to FIG. 1, which illustrates a dictionary word practice unit 10 and a software application 12 within which a user may generate potential vocabulary words 13.

Application 12 may be any software application which has the capabilities to look up words, be it for their definition, translation, synonym, usage examples, etc. For example, application 12 may be a word processing program, a vocabulary program, a word scanning program, a word game, a translation program, etc. Application 12 may be implemented on any computing device, such as a website of the Internet, a personal computer, a hand-held computer, a cellular telephone, etc. Application 12 may be part of Google.com or may be a dictionary website on the Internet. In another embodiment, application 12 may be embodied in a hand-held text scanner, such as any of the Quicktionary brand of products, commercially available from Wizcom Technologies Ltd. of Israel. Such a text scanner may scan words in books or other printed materials.

The word lookup capability of application 12 may be the main purpose of application or it may be one of the many features of the program. In the above example for WORD®, the lookup capability is only one of the application's many features. However it is designed, application 12 typically may comprise a word lookup unit 19 which, in turn, may comprise a derivation engine 16.

Application 12 typically may receive a word 11 from the user to be looked up and may provide it to word lookup unit 19. Unit 19 may first provide word 11 to derivation engine 16, to extract from word 11 a form that may be found in a dictionary, e.g. a headword. For example, the user may have looked up the term “taking off”. To look such a term up in a dictionary, the user would have to look up the word “take” and then find “take off” as one of the possible forms that the word “take” can take on. Derivation engine 16 performs such an operation, converting words in their raw form (e.g. “taking off”) into words in their dictionary form (e.g. first “take” and then “take off”). Application 12 typically may store the looked up words, in their dictionary form, in a dictionary word lookup history list 13.

Alternatively, the person may have an externally generated list, such as one received from a teacher or that he generated in some other way.

In accordance with a preferred embodiment of the present invention, dictionary words 13 may be provided to dictionary word practice unit 10. This can happen automatically, if there is a physical connection between application 12 and unit 10, or the user may type dictionary words 13 into unit 10.

Dictionary word practice unit 10 may, in turn, generate vocabulary exercises for the received dictionary word(s). It will be appreciated that the word may be of any type and of any difficulty and may or may not be on any standard vocabulary word listing used by schools or other educational institutions. Thus, dictionary word practice unit 10 may have its own dictionary and may have the capability, described hereinbelow, to generate vocabulary exercises for any vocabulary word in a standard dictionary, without prior knowledge of what words will need to be exercised.

Practice unit 10 may then generate vocabulary exercises for the vocabulary words. Vocabulary words are not necessarily those that a teacher required the user to learn, however it may consist of any pre-defined teacher list imported into unit 10.

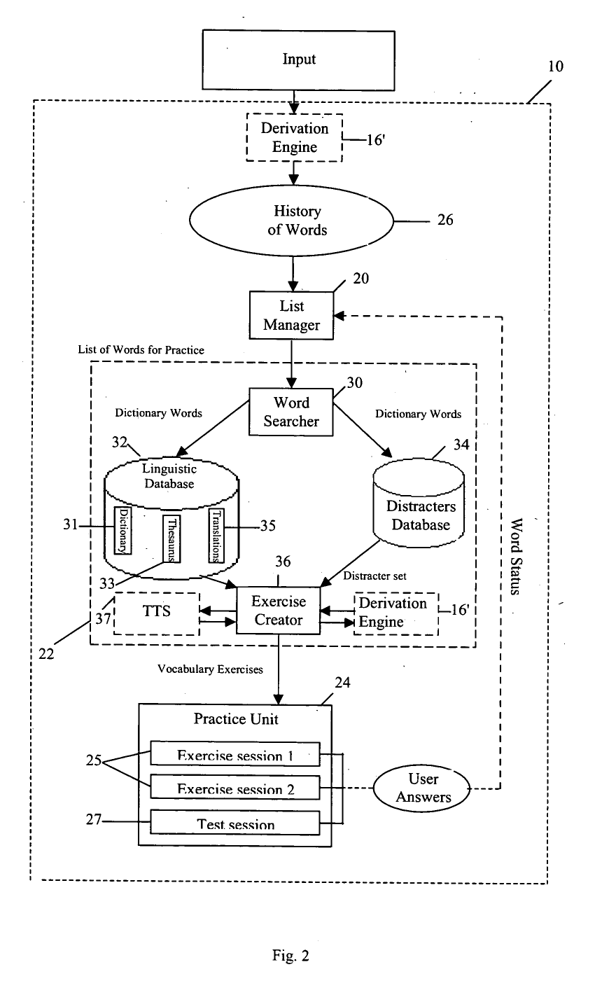

Reference is now made to FIG. 2, which illustrates the elements of dictionary word practice unit 10. Unit 10 may comprise a list manager 20, a dictionary word exercise generator 22 and a practice unit 24. Unit 10 may optionally comprise a derivation engine, here labeled 16′, to convert words from one form to another. In this optional mode, derivation engine 16′ may convert the input to dictionary word practice unit 10, which may be some or all of the words in dictionary word history list 13, a teacher's list of words or words that the user is interested in, into a dictionary list 26 which may be in a format which exercise generator 22 may utilize, as described in more detail hereinbelow.

List manager 20 may prioritize each word in list 26 according to any suitable prioritization such as from the user's manipulation of the list (e.g. deleting, adding or selecting, the user's success rate in previous sessions and/or exposure level to each word. List manager 20 may provide the highest ranked words of dictionary list 26, for example, the top 15 words, to dictionary word exercise generator 22 which may, in turn, create vocabulary exercises for the highest ranked words in list 26.

Practice unit 24 may train and test the user with the generated vocabulary exercises, storing the user's answers to the exercises. Practice unit 24 may also score the user's responses and may determine when the user has sufficiently learned a word.

Practice unit 24 may have different types of sessions. Exercise sessions, labeled 25, may provide the user with the generated vocabulary exercises and may provide the correct answer when the user asks for it. Test sessions 27, on the other hand, may test the user's knowledge of the vocabulary words and thus, may not provide the correct answer.

In an optional mode, indicated by the dashed lines, practice unit 24 may provide the status of each dictionary word to list manager 20 which may, if desired, instruct generator 22 to create further exercises for the words not properly learned.

Dictionary exercise generator 22, a word searcher 30, a linguistic database 32, a distracter database 34 and an exercise creator 36. Word searcher 30 may search databases 32 and 34 for the current dictionary word provided by list manager 20 and exercise creator 36 may create exercises from the information provided by databases 32 and 34.

Linguistic database 32 may comprise an electronic dictionary 31 which is tagged and/or edited to indicate aspects of each definition stored therein and a thesaurus 33 which may provide synonyms and antonyms for the words in the dictionary. Other linguistic information about a word, such as its pronunciation, its translation to another language (as a translation dictionary 35), etc., may also be stored in linguistic database 32. Pronunciation may be provided by a text-o-speech (TTS) system 37 that may be capable of generating voice from given texts. An exemplary text-to-speech system may be that of ScanSoft Inc of the USA.

There are a multiplicity of commercially available electronic dictionaries, any of which may be suitable as the basis for dictionary 31. For example, the Longman Advanced American Dictionary, commercially available from Pearson Education Limited 2000 of the USA, may form a suitable basis.

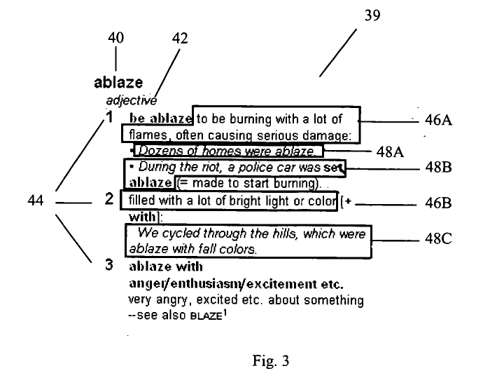

The entries of electronic dictionary 31 may be tagged to indicate the parts of the definitions stored therein. For example, FIG. 3, to which reference is now briefly made, shows an entry 39 for the headword “ablaze”. The entry comprises the headword itself, labeled 40, a notation 42 of the part of speech (in this example, an adjective), and a set either of definitions or of forms 44 of the word. In FIG. 3, the word “ablaze” has three forms 44. Each form 44 contains its form (be ablaze, ablaze with, set ablaze), the definition 46 and, sometimes, a usage example 48. FIG. 3 shows two definitions 46A and 46B and three usage examples 48A, 48B and 48C. The third form 44 of the word “ablaze with anger” is an idiomatic expression and has no usage example.

Returning to FIG. 2, thesaurus 33 may be any thesaurus that may provide the synonyms of an inputted word. For example, for the word “ablaze”, the thesaurus may generate at least “afire, burning, alight, aflame”. For example, any of the commercially available thesauruses, such as Roget's II, The New Thesaurus from Houghton Mifflin, Webster's New World Thesaurus from Macmillan USA and Oxford American Desk Thesaurus from Oxford or the one forming part of WORD®, may form the basis for thesaurus 33.

If linguistic database 32 includes translation dictionary 35, there may be a translation for each word in dictionary 31. Similarly, each dictionary word may be associated with a text-to-speech signal of TTS 37.

Distracter database 34 may store words which are commonly confused with the dictionary words in dictionary 31. Thus, for each dictionary word, there may be a corresponding list of “distracters” associated therewith. The distracters may be words which sound similar, or are from the same semantic group or of a similar yet distinct word or are known to be confused with the word. Moreover, the distracters may be of the same grammatical form as the dictionary headwords and/or may be associated with the expected exercises. Distracter database 34 may be generated manually or automatically, as desired. For example, distracter database 34 may have the following list for the word “ablaze”: “aroused, bright, afire, colorful, facetious, passionate, blaze, inflamed, rapid-fire, ignited and entire”.

For each word provided by list manager 20, exercise creator 36 may receive its definition(s) and its synonyms and antonyms, if the latter are available for the word, from linguistic database 32 and its associated set of distracters from distracter database 34. Exercise creator 36 may then utilize any portion of the definition to create an exercise for the dictionary word.

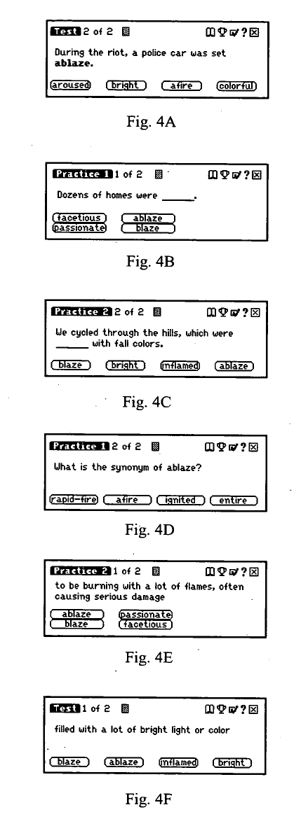

An exemplary set of exercises for the word “ablaze” is shown in FIGS. 4A, 4B, 4C, 4D, 4E and 4F, to which reference is now briefly made. The exercise of FIG. 4A utilizes the second usage example 48B. With this exercise, practice unit 24 may instruct the user to select the word which is closest to the boldface word in the sentence.

To create this exercise, exercise creator 36 may take usage example 48B (i.e. “During the riot, a police car was set ablaze”), may make the dictionary word in boldface and may select three distracters from the distracter list for the word “ablaze”. If necessary, exercise creator 36 may change the distracters, typically using derivation engine 16′, to match the part of speech, tense and person in the usage example.

Exercise creator 36 may then provide practice unit 24 with the sentence to display, the set of four possible answers (the three distracters and the correct answer word) and an indication of the correct answer. Practice unit 24 may then display the exercise and the possible answers, making sure to move the location of the correct answer and to use different distracter sets between exercises.

For the exercises of FIGS. 4B and 4C, practice unit 24 may tell the user to fill in the blanks with the best possible word. Exercise creator 36 may generate these exercises from the usage examples, where the exercise of FIG. 4B may utilize usage example 48A and the exercise of FIG. 4C may utilize usage example 48C. Exercise creator 36 may find suitable possible answers from the synonyms and/or antonyms of the word and/or from the distracter list for the word “ablaze”. Alternatively, distracter database 34 may be annotated to indicate which words are associated with which type of exercise.

The exercise of FIG. 4D asks for a synonym for the word in question. It could similarly ask for an antonym. Exercise creator 36 may take the answers from the thesaurus portion of linguistic database 32 and from the distracter list.

The exercises of FIGS. 4E and 4F are definition exercises, where practice unit 24 may ask the user to select the word whose definition is displayed. The definition of FIG. 4E may be definition 46A and the definition of FIG. 4F may be definition 46B. As for the previous exercises, exercise creator 36 may take the answers from thesaurus 33 and from the distracter list, as well as providing the vocabulary word marked as the correct answer.

It will be appreciated that other types of linguistic information may be stored and thus, other types of vocabulary exercises may also be generated, using the other types of linguistic information. For example, translation exercises and/or pronunciation exercises may be generated.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. Apparatus comprising:
an electronic dictionary; and
a dictionary word exercise generator to generate vocabulary exercises for any requested vocabulary-type word present in said electronic dictionary.

2. The apparatus according to claim 1 and wherein said dictionary word exercise generator comprises an exercise creator to generate said exercises at least from the definition of said word in said dictionary.

3. The apparatus according to claim 1 and wherein said dictionary word exercise generator comprises:
a linguistic database comprising at least said electronic dictionary and a thesaurus, wherein said electronic dictionary comprises a multiplicity of dictionary words, at least a definition for each dictionary word therein and at least one usage example for at least one of said dictionary words and said thesaurus comprises at least synonyms for at least one of said dictionary words;
a distracters database storing at least one distracter set for each said dictionary word, said distracter word being commonly mistaken for said dictionary word; and
an exercise creator to create said exercises for a user selected dictionary word from at least one of: its associated said definition, said usage example, if present, said synonyms and said distracter words.

4. The apparatus of claim 3 and also comprising a practice unit to provide exercise sessions and test session to test a user on his list of selected words.

5. The apparatus of claim 4 and also comprising a list manager to update said list as said user becomes proficient in the words on said list.

6. The apparatus of claim 5 and wherein said list manager comprises means for prioritizing said words on said list.

7. The apparatus of claim 6 and wherein said means for prioritizing comprises means enabling said user to change said prioritization.

8. The apparatus of claim 3 and also comprising a derivation engine at least to convert a word to its dictionary format.

9. The apparatus of claim 8 and wherein said derivation engine also changes format of the distracter set to a desired format.

10. The apparatus of claim 1 and wherein said electronic dictionary comprises at least 25,000 words.

11. The apparatus of claim 1 and wherein said requested vocabulary-type word is a word that a user looked up separately in a lookup unit.

12. The apparatus of claim 11 and wherein said lookup unit includes at least one of a: a predefined list, an electronic dictionary, an Internet website and/or a word lookup application.

13. Apparatus comprising:
an electronic dictionary;
a list manager to receive a user's list of words; and
a dictionary word exercise generator to generate vocabulary exercises for said words in their dictionary format using at least the definitions of said words in said dictionary.

14. The apparatus of claim 13 and wherein said list of words is a list of previously looked up words.

15. The apparatus of claim 14 and wherein said previously looked up words are received from a word lookup application.

16. The apparatus of claim 13 and wherein said list of words is a list of imported words.
